(19) United States
(12) Patent Application Publication
(10) Pub. No.: US 2016/0295819 A1
(43) Pub. Date: Oct. 13, 2016

(54) Method and Apparatus for Controlling Irrigation and Lighting

(71) Applicant: Frederick Michael Porter, Wahroonga (AU)

(72) Inventor: Frederick Michael Porter, Wahroonga (AU)

(21) Appl. No.: 15/034,534

(22) PCT Filed: Oct. 24, 2014
(86) PCT No.: PCT/AU2014/001008

§ 371 Date: May 4, 2016

(30) Foreign Application Priority Data
Nov. 7, 2013 (AU) 2013904299

(51) Int. Cl. A01G 25/16; G05D 7/06; G05B 15/02; A01G 7/04

(52) U.S. Cl. CPC A01G 25/16; A01G 7/045; G05D 7/0676; G05B 15/02

(57) ABSTRACT

An automation apparatus for controlling irrigation and garden lighting, the apparatus comprising: one or more Switch Modules that are adapted to activate and deactivate one or more managed devices; at least one Control Module coupled to each of the one or more Switch Modules for communicating command data that causes a predetermined Switch Module to activate or deactivate a predetermined respective one or more managed devices; and a Power Supply Module coupled to power cable for providing a source of electrical power to each of the Control Module and the one or more Switch Modules. The apparatus can further include one or more Sensor Modules, the Sensor Module being adapted to obtain sensor data from one or more sensor devices and communicate the sensor data to at least one Control Module. Data communication between the Control Module and Switch Modules or Sensor Modules can be bi-directional and transported across the power cable.

### FIELD OF THE INVENTION

The present invention relates to automated control systems and in particular to automated control systems for irrigation and/or lighting.

The invention has been developed primarily for use as an automated control system for controlling irrigation and lighting—and will be described hereinafter with reference to this application. However, it will be appreciated that the invention is not limited to this particular field of use.

### BACKGROUND OF THE INVENTION

Any discussion of the prior art throughout the specification should in no way be considered as all admission that such prior art is widely known or forms part of the common general knowledge in the field.

Known systems for irrigation automation, use multi-wire cabling, typically with one common conductor and one specific conductor for each solenoid under control. Once connected/configured a system cannot be easily expanded, typically requiring more wiring hack to the controller.

Conventional systems use a “manifold” layout where the water supply is delivered to a manifold which splits the water supply into several (usually 4 or 8) separate smaller pipes each controlled by a solenoid valve. These separate pipes are then extended to teach the desired irrigation area(s).

Furthermore conventional irrigation systems cannot control garden lighting.

It will be appreciated that, costs are relatively high for current commercial irrigation systems and landscape lighting systems (typically requiring separate systems).

There is a need in the art for an improved method and apparatus for controlling irrigation and lighting.

### OBJECT OF THE INVENTION

It is an object of the present invention to overcome or ameliorate at least one of the disadvantages of the prior art, or to provide a useful alternative.

It is an object of the invention in a preferred form to provide an automated control system for controlling irrigation and/or lighting.

### SUMMARY OF THE INVENTION

According to an aspect of the invention there is provided an automation apparatus (or system) for controlling irrigation and garden lighting, the apparatus comprising:
one or more Switch Modules that are adapted to activate and deactivate one or more managed devices;
at least one Control Module coupled to each of the one or more Switch Modules for communicating command data that causes a predetermined Switch Module to activate or deactivate a predetermined respective one or more managed devices;
a Power Supply Module coupled to power cable for providing a source of electrical power to each of the Control Module and the one or more Switch Modules.

Preferably, data communications s transported across the power cable. More preferably, data communication is bi-directional.

Preferably, the Switch Module provides one or more output ports for supplying a predetermined power source to a respective switched device. More preferably, the predetermined, power source is user configurable. The apparatus preferably includes a Switch Module as herein disclosed.

Preferably, the apparatus includes a Sensor Module. More preferably, the Sensor Module is adapted to obtain sensor data from one or more sensor devices and communicate the sensor data to at least one (or a plurality of) Control Module and/or at least one (or a plurality of Switch Module. The format or mode of sensor data received is preferably user configurable. Most preferably, the Sensor Module is further adapted to provide a predetermined power source to the sensor device. The predetermined power source is preferably user configurable. The apparatus preferably includes a Sensor Module as herein disclosed.

Preferably, the apparatus includes an external Power Supply Module that is adapted to activate and deactivate one or more managed devices by providing external operating power to the managed device. More preferably, the apparatus includes an external Power Supply Module as herein disclosed.

Preferably, a Control Module device presents an interface for configuring and monitoring operation of the apparatus. More preferably, a Control Module device presents a web based interface that is accessible from as remote computing device. Most preferably the interface is provides full remote control and monitoring of the apparatus.

According to an aspect of the invention there is provided a user access interface for a processor device, the processor device being adapted to control irrigation and garden lighting, the processor device being coupleable and/or responsive to database information having real-time, schedule and/or configuration data; the interface comprising; a control is program adapted to enable configuring and monitoring operation of an automation apparatus for controlling irrigation and/or garden lighting as herein disclosed.

### BRIEF DESCRIPTION OF THE DRAWINGS

A preferred embodiment of the invention will now be described, by way of example only, with reference to the accompanying drawings in which:

FIG. 1 is a schematic view of an embodiment apparatus for con irrigation and garden lighting according to the invention:

FIG. 2 is a schematic view of an embodiment apparatus for controlling irrigation and garden lighting according to the invention;

FIG. 3 is a schematic view of an embodiment apparatus for controlling irrigation and garden lighting according to the invention; and

FIG. 4 is a schematic view of an embodiment apparatus for controlling irrigation and garden lighting according to the invention.

### PREFERRED EMBODIMENT OF THE INVENTION

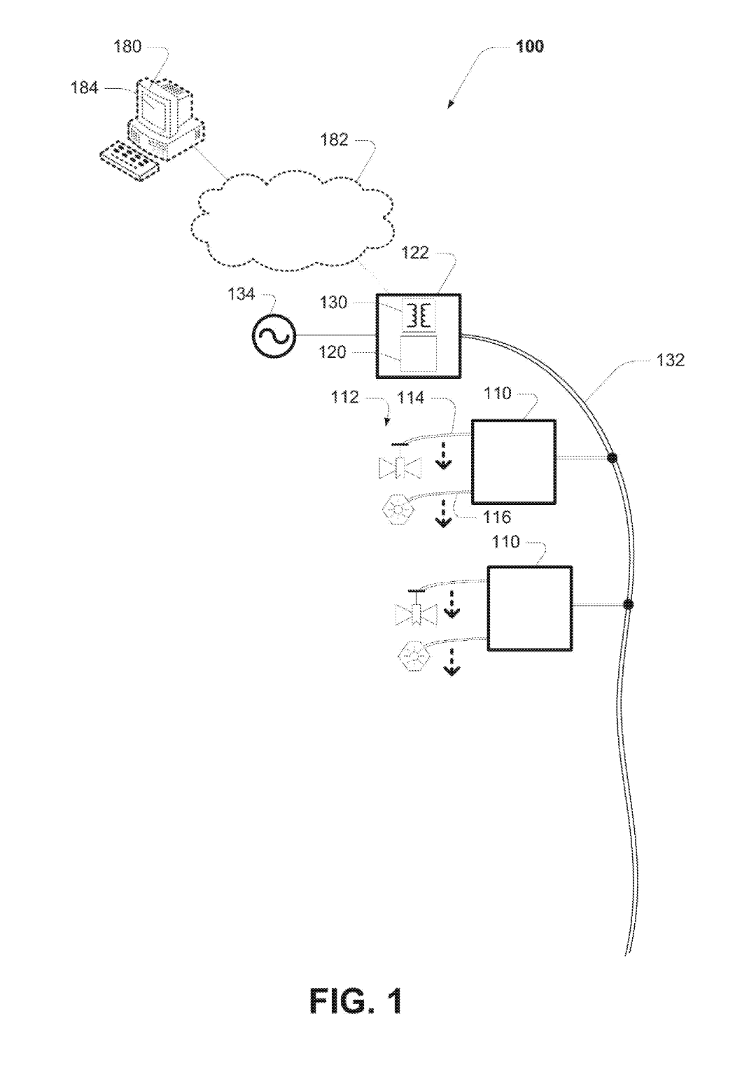

FIG. 1 through FIG. 3 shows embodiment automation apparatus (or systems) (100,200,300) that can be used for controlling irrigation and garden lighting.

FIG. 1 shows an embodiment automation system 100 for controlling irrigation and garden lighting. The system can comprise:
one or more Switch Modules 110 that are adapted to activate and deactivate one or more managed devices 112;
at least one Control Module 120 coupled to each of the one or more Switch Modules for communicating command data that causes a predetermined Switch Module to activate or deactivate a predetermined respective one or more managed devices;
a Power Supply Module 130 coupled to power cable 132 for providing a source of electrical power to each of the one or more Switch or Sensor Modules.

In this embodiment, a Control Module and the Power Supply Module are included in a single controller unit 122, with the Power Supply Module 130 coupled to a mains power outlet/source 134. Alternatively, as shown in FIG, 2, the Power Supply Module 130 can be separately housed 232 and coupled to the power cable 132, while the Control Module 120 can be separately coupled to the power cable for transmitting command data by a signal coupling device and/or accessing operating power. However, it will be appreciated that a Control Module can be separately coupled to a mains general power outlet for accessing operating power

In this embodiment, the command data is communicated from the Control Module and/or one or more Switch Modules to the Switch Modules Over the power cables. While the Power Supply :Module typically provides a 24V AC source, it will be appreciated that other power source voltages may be used. The data communication is a broadcast protocol that can be received by all modules suitably coupled to the power cables with an appropriate transceiver. The data communication can be bidirectional between modules.

It will be appreciated that the Control Module can be optionally coupled to a computing device 180, for example, by a wired and/or wireless data network 182. The computing device can present an interface 184 for configuring and monitoring operation of the Control Modules. For example, the apparatus (together with firmware and web compatible interface software) can provide a user with full remote control and monitoring, which may be accessible from the internet on web enabled computing devices or Smart-Phones.

Each of the one or more Switch Modules is coupled to the power cable for receiving electrical power and command data. In an embodiment, the provided electrical power is in the form of mains power (for example, 24V AC), and the Switch Module internally transforms this input power source to a user configurable output switch voltage (for example an output switch voltage of either 24V AC at 114 or 12V AC or 12 V DC at 116), it will be appreciated that the Switch Module can internally transforms this input power source to a range of voltages in either alternating current (AC) or direct current (DC), which can be selected as a user configurable output switch voltage. Typically, the Switch Module presents a plurality of switch terminals that are grouped or identified on the basis of their output switch voltage and allocated an addressable port number. The Switch Module, by activating or deactivating a switch port, is adapted to activate and deactivate the respective addressed is managed device. For example, the Switch Module can be used to activate or deactivate (turning ON and turning OFF) a standard 12V AC garden light and/or standard 24V AC irrigation solenoid valves.

In an embodiment, the Switch Module may further generate a variable voltage at one or more addressable ports. This Switch Module can be used to provide variable power to a respective managed device. For example, this Switch Module manages dimming of garden lights.

As the communication over power lines is a multiple access communication protocol, the system is easily scalable, through access to a single powerline cable. It will be appreciated that this system can comprise a relatively small system with only a few devices such as for small gardens) or expanded to a relatively large system that includes hundreds of devices covering a wide area (such as for nurseries, parks, golf courses, entertainment venues or agricultural fields, etc).

Each Switch Module and Sensor Module can have a unique primary identifier (identification number). This identification number (or an indicative reference) can be presented to the user (typically via a web base interface) and a physical label on the module (typically on the outside of the enclosure). This primary identifier is not user alterable—but can be associated with a user defined label.

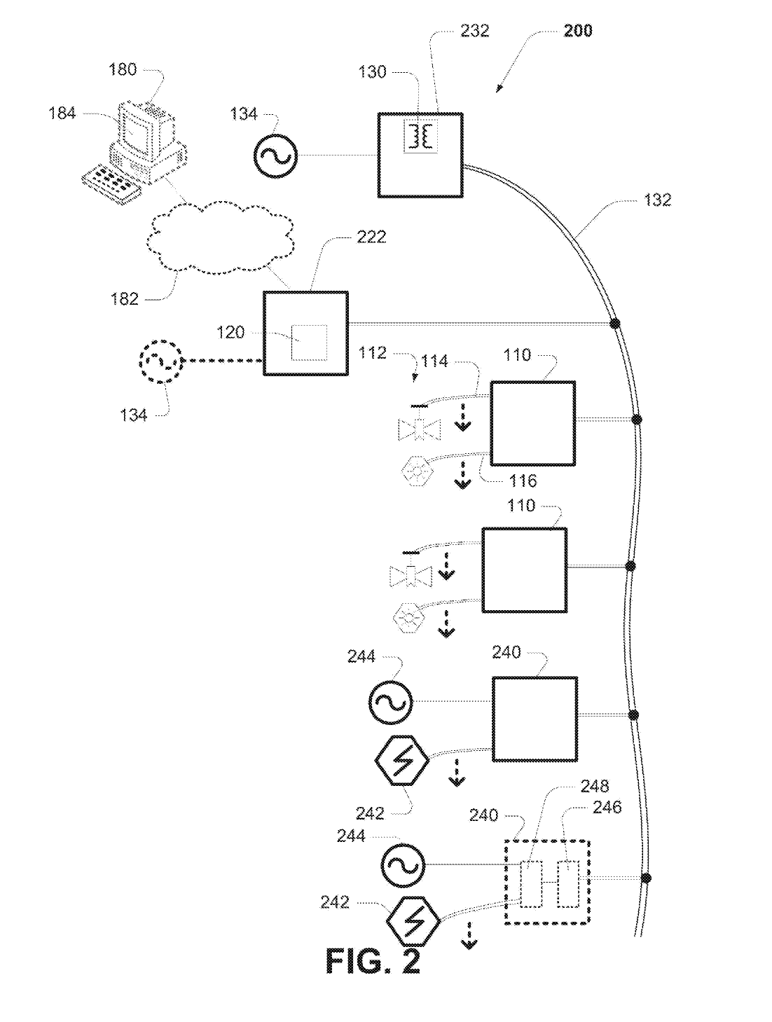

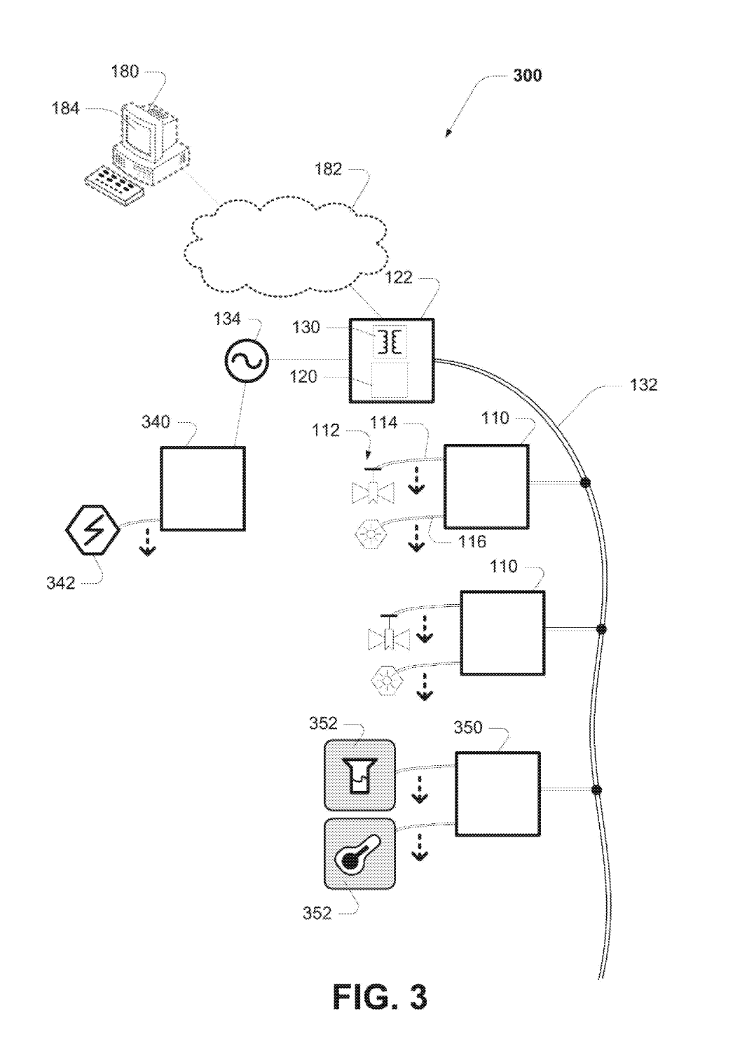

FIG. 2 and FIG. 3, an embodiment automation system (200, 300) can further include one or more modules selected from the set comprising;
Switch Module 110 that is adapted to activate and deactivate one or more managed devices;
Mains Switch Module 240 that is adapted to activate and deactivate one or more managed devices 242 by providing external operating power 244 to the managed device (See FIG. 2);
Sensor Module 350 is adapted to obtain sensor data from one or more sensor devices 352 and communicate the sensor data to at least one Switch Module 110 and/or a Control Module 122. (see FIG. 3).

Referring to FIG. 2, for managed devices that require more electrical power than can be provided through the system power cables, a Mains Switch Module 240 can be additionally coupled to a mains power supply 244 (for example a standard 240V AC or 110V AC general power outlet). The Mains Switch Module is coupled to the main power cables for, at least, receiving command data that causes a predetermined Mains Switch Module to activate or deactivate a predetermined respective one or more managed devices.

It would be appreciated that Mains Switch Module 240 can comprise a Switch Module 246 and a relay unit 24$ controlled by the Switch Module for controlling selective switching of a mains power source to activate or deactivate a predetermined respective one or more managed devices. In this embodiment, the Switch Module portion activates or deactivates the relay unit for respectively activating or deactivating a predetermined respective one or more managed devices.

Referring to FIG. 3, it will be appreciated that a Sensor Module 350 can enable inclusions of environmental sensor devices 352 (such as moisture sensor, illumination sensor, humidity sensor, flow rate sensor, temperature sensor, rain sensor, proximity sensor and other sensor devices). The Sensor Module being adapted to obtain sensor data from one or more sensor devices 352 and communicate the sensor data to at least one Switch or Mains Switch Module 110, 240 and/or one Control Module 122. The Control Module 122 can be programmed or configured to receive (by request or through broadcast) the sensor data, and then based on the sensor data control one or more Switch or Mains Switch Modules.

Controller Module

In an embodiment, a Control Module is typically housed in a robust windowed enclosure that is suitable for installation in an indoor or covered location.

A Control Module is typically connected to a mains power general purpose outlet (for example, 240V AC mains); and a powered 24V AC transformer powerline.

A Control Module typically includes a web server that presents a user interface across a data network (for example Ethernet or WiFi) for configuring and monitoring a Control Module (and system generally).

A Control Module typically includes a transceiver coupled to the powerline cables and the mains supply cables for transmitting control data and receiving acknowledgements to and from the Switch Modules, Mains Switch Modules and/or sensor data from Sensor Modules. The transceiver filters out the mains power frequency and noise components.

The Control Module can address and manage a significant number of devices (for example 300 devices). A Control Module can automatically “discover” any attached Switch Module, or Mains Switch Module, or Sensor Module connected to the powerline (or mains), to provide (typically via web interface) the ability to enter the module/device details for facilitating subsequent control thereof.

With all the Switch Modules and/or Sensor Modules discovered and appropriately identified, the Control Module can further provide options for scheduling, alarming and/or data logging. Communications (emails) can be automatically sent upon the occurrence of a predetermined/specified condition being met.

By way of example only, the data communication complies with control networking standard ANSI/CEA-709.1-B.

Power Supply Module

A Power Supply Module is typically a power source that is configured to provide necessary voltage and current for a system. The power supply module is a 24V AC transformer that is coupled to a power line cable that is typically in the form of a waterproof insulated two wire conductor cable (having a suitable current capacity). The power cable is laid across the area to be controlled and can be buried for extra protection (especially from sunlight degradation).

The powerline cable is coupled to each Switch Module, which can then be connected to standard 24V AC irrigation solenoids or standard 12V LED lighting.

The powerline cable is coupled to each Sensor Module, which can then be connected to standard environmental sensors.

Typically, all devices connected to the powerline cable can derive all necessary power for operating infernal logic, communications, and any connected devices from the powerline.

It will be appreciated that long power line cables: multiple power sources may be required to accommodate voltage drops along the cable. A “repeater” communication protocol can be enabled wherein selected modules relay data being transmitted; or repeater modules installed atom the powerline cable for receiving and rebroadcasting data communications.

A powerline cable can be branched. A single Control Module can control more than one powerline cable. A plurality of Control Modules can be coupled to a powerline cable.

Switch Module

A Switch Module can be encased/enclosed in a robust waterproof/water resistant housing. It can be located underground and/or along the powerline. It is expected to allow exposure to weather conditions of temperatures are between 10-50 Deg C. and humidity of 0-100%. However it is preferable to provide protection for these devices such as is afforded by standard irrigation valve boxes.

A Switch Module includes a transceiver element coupled to the powerline (cables) for enabling data communication reception of command data and data communication transmission of status data, wherein data can be transmitted over the powerlines. A Switch Module further includes a processor element or device) coupled to the transceiver element receiving and processing command data and transmitting status data.

It will lie appreciated that coupling of the Switch Module to a powerline can, by way of example only, be made without breaking the powerline cable. Installation of a Switch Module can be achieved by removing a portion of insulation from the powerline conductors twisting the module's external power lead wires around, and then waterproofing the connection with self-amalgamating tape or similar protection. Alternative methods of coupling the Switch Module to a powerline can, by way of example, include using an insulation displacement connector (IDC) or making a terminal junction in the powerline and coupling the module power lead wires. It will be appreciated the connection is typically made water-resistant or weather-resistant.

A Switch Module can internally generate a plurality of output switch voltages (for example, 12V AC and/or 12V DC and/or 24V AC). It will be appreciated that over current protection and short circuit protection can be provided for each switch output port. An alarm (audible, visual or digitally transmitted) can be activated upon occurrence of a fault condition.

A Switch Module can be factory programmable and/or user configurable. A user interface provided by a Control Module can enable a user (typically via a web based interface) to configure each Switch Module for irrigation and/or lighting as well as associate meaningful text for such parameters as location or zone name or number, etc. Factory upgrading of the software of both the interface software and the device CPU software can be initiated through a web based interface.

A Switch Module can include an electronically erasable programmable memory used to store non-volatile device configuration and user data. Upon disconnection and reconnection of a Switch Module to the powerline, specific and relevant configuration properties are retained.

Sensor Module

A Sensor Module can be encased/enclosed in a robust waterproof/water resistant housing. It can be located underground and/or along the powerline. It is expected to allow exposure to weather conditions of temperatures are between 10-50 Deg C. and humidity of 0-100%.

However it is preferable to provide protection for these devices such as is afforded by standard irrigation valve boxes.

A Sensor Module includes a transceiver element coupled to the powerline (cables) for enabling data communication reception of command data and data communication transmission of status/sensor data, wherein data can be transmitted over the powerlines. A Switch Module further includes a processor element (or device) coupled to the transceiver element receiving and processing command data, and transmitting status/sensor data.

One or more environmental sensor devices can be connected to a Sensor Module. The Sensor Module can be factory programmed and/or user configured for different current and/or voltage outputs for powering a respective sensor device. Sensor devices are available from many different manufacturers. Sensor devices typically require a power source in the form of a DC voltage up to 12 volts, which can be configured for each power connection port. Sensor devices typically provide an output signal of either a voltage or a current that represents the parameter measured (e.g. temperature, moisture, etc.), which can be configured for each signal port. A power connection port a and a signal port are typically associated with (coupled to) each sensor device.

A Sensor Module reads the sensor's output voltage (or current) signal that represent the particular quantity (e.g. temperature, etc.) and translates this “raw” signal value (for example, mV or mA) into a normalised unit measure data (e.g. degrees Celsius) and they provides this measure data to a Control Module. A Control Module can present this measure data on a user interface and/or test the measure data for triggering a predetermined criteria or control function.

It will be appreciated that, each sensor device (from different manufacturers and with different outputs) will typically have conversions between the raw signal and the measure data, which requires a predetermined conversion table (or function) to be applied by the Sensor Module (and/or a Control Module). Typically, these conversion tables can be downloaded automatically by a Control Module. The user can configure a sensor device coupled to a Sensor Module by selecting an appropriate device description from a drop down in a user interface.

Mains Switch Module

A Mains Switch Module is similar in operation to a Switch Module, but is used to control activation and deactivation of mains power devices. The Mains Switch Module is coupled (via the Control Module) to the main powerline (typically low voltage power source and physical communication channel) and connected to a normal main general power outlet (GPO—typically 240V AC or 110V AC) and provides one or more switchable mains pow outputs for controlling suitable mains power devices (including pumps and fans).

Each Mains Switch Module can be uniquely identifiable by a Control Module.

Each Mains Switch Module can include a processor device and transceiver coupled to the powerline and to the mains power supply. The processor device can further control switching of the one or more switchable mains power outputs (ON/OFF functions) and monitoring current drawn by each output. The status (and current data) for each switchable mains power output can be transmitted to a Control Module. It will be appreciated that the monitored current drawn from each switchable mains power output can indicate operation of the connected device.

In an embodiment, a Mains Switch Module provides independent (and monitored) switchable mains power outputs (typically with a 10 amp total current capacity).

An alternative embodiment Mains Switch Module 340 is similar in operation to a Switch Module, but connected to a mains power outlet/source 134. This Mains Switch Module is used to control activation and deactivation of suitable mains power devices 342 (including pumps and fans).

The Mains Control Module 340 sends and receives data signals and/or communications signals via mains (high voltage) wiring 134. The Control Module 120, in this embodiment, can enable communication across the power cable 132 and mains (high voltage) wiring 134. In this embodiment the mains power supply (typically 240V AC or 110V AC) provides both power to the Mains Control Module 340 and communication between the Mains Control Module 340 and the Control Module 120. Each Mains Control Module 340 can be uniquely identifiable by a Control Module.

In an embodiment, by way of example only, a Mains Control Module 340 may be connected to a 240 VAC supply and can control devices up to a 10 amp total current capacity. Mains Control Module 340 is configured to communicate data to and from the Control Module, such as an on/off status and the current (amps) that it is providing to a connected load 342.

User Interface

In an embodiment, the Control Module presents as user interface that enables configuration of modules in the systems and presents status of each connected module and device.

By way of example, a user interface can include any one or more of the following features:
Enable association (and display of a meaningful descriptor (for example text descriptor for location and/or function) for each module;
Enable association (and display) of a meaningful descriptor (for example text descriptor) for each device (sensor device or controlled device) coupled to the respective module—wherein the module descriptor can be further associated with the device;
Enable independent configuration of each module controlled output port;
Enable association of a zone (number and/or location) to module controlled output port;
Enable configuration of module controlled output port to as predetermined output voltage (for example, unused, 24V AC or 12V AC or 12V DC);
Enable configuration of module controlled output port to an associated maximum Time-On (Safety duration cut out protection);
Default configuration of module controlled output port to an associated maximum (safety default can be 1 hour);
Enable configuration of module controlled output port to predetermined light dimming levels (using Pulse Wave Modulation to provide a range from full off to full on in a smooth fashion);
Enable configuration of module control port to a time ON duration setting (day; hour; minute; second);
Enable configuration of module controlled output port to manual ON/OFF—toggle commands;
Enable configuration of a module controlled output port to a scheduler date/time) ON/OFF commands;
Enable configuration of module controlled output port to an automatic countdown during duration of time;
Enable configuration of module controlled output port to associate a range of current drawn (for example specifying lighting or irrigation solenoid);
Enable broadcast commands for ALL devices OFF;
Enable broadcast commands for ALL irrigation OFF;
Enable broadcast commands for ALL lights ON/OFF;
Presenting current drawn from a module controlled output port;
Presenting status for a module controlled output port;
Presenting status for a measurement device;
Enable configuration of trigger conditions the enabling or disabling a controlled output port.

### Example Embodiment

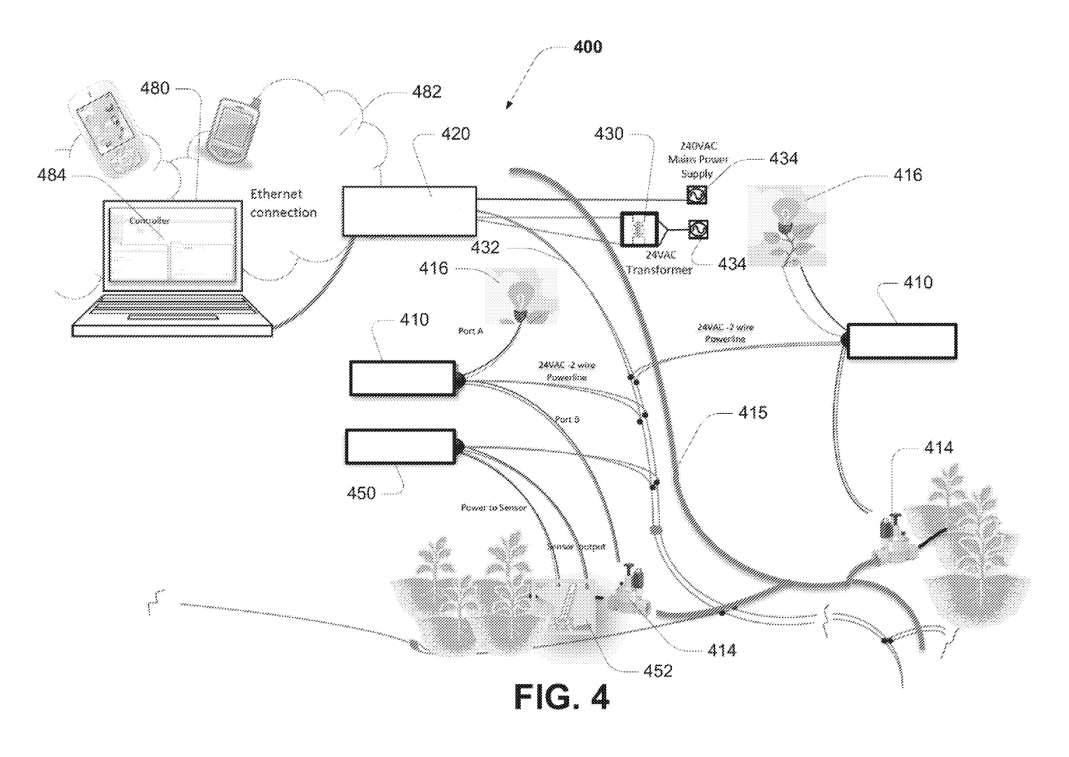

Referring to FIG. 4, by way of example, an embodiment automation system 400 can include a Control Module 420 coupleable to a remote computing device 480 via a data network 482 (for example, local area network or the internet). A Control Module having a web server that presents a user interface 484 to the remote computing device. A Control Module is connected to a standard general power output (240V AC mains power point) 434.

A low voltage (24V AC) source is provided and connected to a Control Module. A two wire insulated cable (“the powerline” cable) 432 is coupled to a Control Module and installed across the desired area/landscape for connection to Switch Modules 410 and sensor modules 450.

The Control Module communicates with other modules (the example Switch Modules 410 and sensor modules 450) along the two wire insulated cable (“the powerline”). This cable provides a low voltage (24V AC) supplied from the transformer 430.

The user can connect from one or more modules (Switch Modules and sensor modules) to the powerline for controlling and monitoring lighting and/or irrigation solenoid valves. It will be appreciated that a user can provide Mains Switch Modules, each coupled to a mains power supply (not shown in FIG. 4).

In this embodiment, each Switch Module has two output “ports”. Each port has two coloured wires to which is connected either an irrigation solenoid 414 or LED lights 416. It will be appreciated that the solenoid is further coupled to a water source (irrigation pipe) 415. Each output port can be independently controlled as either a standard 24V AC irrigation solenoid valve or one or more LED lights (the number being limited by the available power). Power to the modules are provided from the powerline and through selected (or configured) voltage or current regulators.

By installing multiple Switch Modules along the powerline it is possible to control numerous irrigation zones and/or numerous LED lights. This enables full landscape control of watering and lighting (with dimming).

Unlike conventional multi-wire irrigation cables, the 2 wire low voltage cable powerline can be branched to suit the topology of the outdoor environment, while uniquely identifying coupled modules. Additional lighting and irrigation areas (called “zones”) can be easily added. Switch Module output ports can be reconfigured from irrigation control to lighting control or vice versa (obviously with changes to their respective connected loads). It will be appreciated that there are labour savings for laying the powerline when compared to conventional multi-core cabling.

A remote computing device can control the system using a web based interface provided by a Control Module. A user can configure, monitor, schedule and immediately control the output ports of connected modules and devices. Any person with the correct password can control the system, thereby allowing remote control by one or more individuals.

The irrigation and/or lighting zones can be programmed to overlap in times. This overlap is very useful for irrigation systems for preventing or limiting “water hammer” (that can damage piping)—typically occurring when zones are turned OFF.

Each Switch Module 410 (and associated devices 414, 416) and each sensor module 450 (and associated devices 452) are uniquely identifiable by a Control Module 420. Each module has a factory programmable CPU/MPU inside. Each module has a non-volatile memory for storing user configuration data, for assisting recovery from a power outage.

The data communication can work in a “master-slave” protocol or as a “peer-to-peer” configuration.

In an embodiment, a peer-to-peer configuration can provide greater control and complexity, wherein each module can be configured to enable transmission of commands to another module(s). For example, a sensor module coupled to a moisture sensor device can be programmed to detect a predetermined level of moisture and directly command a specific irrigation zone Switch Module(s) to perform a watering cycle.

Each irrigation for lighting) zone can have a default or user configured maximum operating time (“Maximum Time ON”). If the user enables a zone and forgets to disable it the system can automatically turn the zone off at the maximum time value. This feature is useful for both irrigation in limiting overwatering/flooding and lighting in limiting, power usage.

Each Switch Module port is independently configurable and controllable. A user can specify durations in days, hours, minutes and seconds for the efficient use of energy and water. This fine level of control is especially useful for hydroponics users where fertilizer is injected into the irrigation pipes, and irrigation cycle duration is critical.

As there is limited water pressure and flow, as well as the different requirements of different plants (lawn, natives, pot plants, etc.), a Control Module has the capacity to control a number of zones, while retaining that capability to be expanded to more zones for new areas or splitting existing zones as plantings are expanded and/or it becomes obvious that existing zones need to be split into additional zones to supply the optimum amount of water to plank and to conserve water.

Separate from the low voltage powerline, an automation System can optionally include one or more Mains Control Modules that enable switching of an external mains power supply (general power outlet). This module has to separate connection to a general power outlet, and provides two switched mains power output sockets that can be used to switch mains powered devices. This module can provide automation and control of any appliance requiring mains power. e.g. pumps, fans, lights, ventilation, security, etc. This Mains Control Module is coupled to both the mains supply and to the 24V AC powerline and is able to communicate with other connected modules on either the mains supply and/or the low voltage powerline.

A user can use the web interface to configure, monitor, schedule and immediately control the output ports of connected modules and devices. The user can also set up a plurality of separate schedule files (e.g. for Summer, Winter, Autumn Spring or January, February, etc.) for irrigation, illumination, automation. A sophisticated scheduling can allow schedules to be based on sunrise and sunset. For example, plants could be scheduled for irrigation one hour after sunrise. For example, garden lighting could be set to turn on at sunset for a specified duration time. By way of example, a Control Module can receive user input of latitude and longitude co-ordinates and calculate sunrise and sunset times. Advanced scheduling functionality can also be used to warn users if they attempt to irrigate at times that are not permitted by local watering restrictions. A further scheduling feature can include a “wet and wait” function wherein the output port cycles on and off for the duration of a period (the on duration can be predetermined or configured), thereby avoiding continuous irrigation of a dry surface that can result in runoff causing erosion and inappropriate irrigation.

Each Switch Module output port can feature an “alarm”. For example, if the connected load (lighting or irrigation solenoid) attempts to draw an over-limit current, the Switch Module can disable the load and display art alarm condition (locally arid/or on a user interface). This feature is beneficial in alerting the user of a short circuit condition and thereby containing damage that may occur due to irrigation or illumination not occurring as expected. The user interface can also monitor and display electrical current drawn by each port on each Switch Module. This feature can enables a user (or automatically) to determine correct functioning. For example, if an irrigation zone should be ON, but the current being drawn is displayed as zero, then the solenoid is not operating correctly and irrigation is not occurring. If lighting is drawing zero current then it is not operating correctly.

Feature Advantages

By way of example, an embodiment automation system can provide any one or more of following advantages or benefits:
Enables user configurable combined automation of irrigation and lighting (time based or event based);
Enables a combined automation of irrigation and lighting, with the option to scheduling based on sunrise and/or sunset;
Enables dimmable control of garden lighting;
Enables user configuration of dimming illumination (0 to 100%);
Enables user configuration of irrigation and/or illumination zones (or groups);
Enables user control via a web based interface;
Enables remote control and configuration;
Enables remote display of status and, configuration data;
Enables independent station (module) programming—either centrally via Control Module or peer to peer communication;
Enables master-slave and “peer-to-peer” control communication;
Enables configuration of an email alert for occurrence of a predetermined alarm condition;
Enables reconfiguration of switch or monitor modules for new purposes;
Enables power and data to be communicated over a powerline;
Enables accurate scheduling using a specific start time and duration or completion time;
Enables calendar management, such as 7 day calendar/31st of month exclusion/Interval (days) etc.
Enables manual on/off;
Enables integration of sensor devices (e.g. rain, soil moisture);
Enables integration of mains power devices (for automation);
Enables use of a two corewire powerline cable (which is easily extendable at anypoint and in any direction);
Enables scalability of installations;
Enables irrigation monitoring for water conservation;
Enables dollar and labour savings through simplified installation and configuration.

Interpretation

It will be appreciated that the illustrated embodiment teach an automated control systems for controlling irrigation and/or lighting.

It would be appreciated that, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described here of an apparatus embodiment is an example of a means for carrying out the function performed by the element for the purpose of carrying out the invention.

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment.

Thus, one embodiment of each of the methods described herein is in the form of a computer-readable carrier medium carrying a set of instructions, e.g. a computer program that are for execution on one or more processors.

Unless specifically stated otherwise, as apparent from the following discusions, it is appreciated that throughout the specification discussions utilizing terms such as “processing”, “computing”, “calculating” “determining” or the like, can refer to the action and/or processes of a computer or computing system, or similar electronic computing device, that manipulate and/or transform data represented as physical, such as electronic, quantities into other data similarly represented as physical quantities.

In a similar manner, the term “processor” may refer to any deice or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described, herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken is included.

Unless the context clearly requires otherwise, throughout the description and the claims, the is words “comprise”, “comprising”, and the like are to be construed in an inclusive sense as opposed to an exclusive or exhaustive sense; that is to say, in the sense of “including, but not limited to”.

Similarly, it is to be noticed that the term “coupled”, when used in the claims, should not be interpreted as being limitative to direct connections only. The terms “coupled” and is “connected”, along with their derivatives, may be used. It should he understood that these terms are not intended as synonyms for each other. Thus, the scope of the expression “a device A coupled to a device B” should not be limited to devices or systems wherein an output of device A is directly connected to an input of device B. It means that there exists a path between an output of A and an input of B which may be a path including other devices or means. “Coupled” may mean that two or more elements are either in direct physical or electrical contact or that two or more elements are not in direct contact with each other but yet still co-operate or interact with each other.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Reference throughout this specification to “one embodiment” or “an embodiment” means that a particular feature, structure or characteristic described in connection with the embodiment is included in at least one embodiment. Thus, appearances of the phrases “in one embodiment” or “in an embodiment” in various places throughout this specification are not necessarily all referring to the same embodiment, but may refer to the same embodiment. Furthermore, the particular features, structures or characteristics may be combined in any suitable manner, as would be apparent to one of ordinary skill in the art from this disclosure, in one or inure embodiments.

Similarly it should be appreciated that in the above description of exemplary embodiments of the invention, various features of the invention are sometimes grouped together in a single embodiment, figure, or description thereof fir the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description. Although the invention has been described with reference to specific examples, it will be appreciated by those skilled in the art that the invention may be embodied in many other forms.

It will be appreciated that an embodiment of the invention can consist essentially of features disclosed herein. Alternatively, an embodiment of the invention can consist of features disclosed herein. The invention illustratively disclosed herein suitably may be practiced in the absence of any element which is not specifically disclosed herein.

1. An automation apparatus for controlling irrigation and garden lighting, the apparatus comprising:
one or more Switch Modules that are adapted to activate and deactivate one or more managed devices;
at least one Control Module coupled to each of the one or more Switch Modules for communicating command data that causes a predetermined Switch Module to activate or deactivate a predetermined respective one or more managed devices; and
a Power Supply Module coupled to power cable for providing a source of electrical power to each of the Control Module and the one or more Switch Modules.

2. The apparatus according to claim 1, wherein data communication between the Control Module and Switch Modules are transported across the power cable.

3. The apparatus according to claim 2, wherein the data communication is bi-directional.

4. The apparatus according to claim 3, wherein the Switch Module provides one or more output ports for supplying a predetermined power source to a respective switched device.

5. The apparatus according to claim 4, wherein the predetermined power source is user configurable.

6. The apparatus according to claim 1, wherein the apparatus further includes one or more Sensor Modules, each Sensor Module being adapted to obtain sensor data from one or more sensor devices and communicate the sensor data to the at least one Control Module.

7. The apparatus according to claim 6, wherein format and/or mode of sensor data transmitted by the Sensor Module is user configurable.

8. The apparatus according to claim 6, wherein the Sensor Module is further adapted to provide a predetermined power source to the respective from one or more sensor devices.

9. The apparatus according to claim 8, wherein the predetermined power source provided to the to the respective from one or more sensor devices is user configurable.

10. The apparatus according to claim 6, wherein the apparatus further includes an external Power Supply Module that is adapted to activate and deactivate one or more managed devices by providing external operating power to the managed device.

11. The apparatus according to claim 6, wherein the Control Module device presents a user interface for configuring and monitoring operation of the apparatus.

12. The apparatus according to claim 11, wherein the Control Module device presents a web based interface that is accessible from a remote computing device.

13. The apparatus according to claim 11, the user interface provides full remote control and monitoring of the apparatus.

14. An automation apparatus having an user interface for controlling irrigation and garden lighting, the apparatus having a processor device for presenting the user interface, the processor device being adapted to control irrigation and garden lighting, the interface controlling the automation apparatus including:
one or more Switch Modules that are adapted to activate and deactivate one or more managed devices;
wherein data communication processor device and the one or more Switch Modules are transported across the power cable.

15. The apparatus according to claim 14, wherein the interface controls an automation apparatus.

16. The apparatus according to claim 14, wherein the processor device is coupleable to a database having a real-time schedule and/or configuration data.

17. The apparatus according to claim 14, wherein the user interface comprises: a control program adapted to enable configuring and monitoring operation of the one or more Switch Modules.
